(19) United States
(12) Patent Application Publication
(10) Pub. No.: US 2020/0285932 A1
(43) Pub. Date: Sep. 10, 2020

(54) METHOD AND SYSTEM FOR GENERATING STRUCTURED RELATIONS BETWEEN WORDS

(71) Applicant: Wipro Limited, Bangalore (IN)

(72) Inventors: Ankit Kumar Singh, Dhanbad (IN); Amrit Bhaskar, Dumka (IN); Parul Chopra, Dwarka (IN); Sibsambhu Kar, Bangalore (IN)

(21) Appl. No.: 16/358,076

(22) Filed: Mar. 19, 2019

(30) Foreign Application Priority Data
Mar. 8, 2019 (IN) 201941009036

(51) Int. Cl. G06N 3/02; G06F 16/28; G06N 7/00; G06N 5/02

(52) U.S. Cl. CPC G06N 3/02; G06N 5/02; G06N 7/005; G06F 16/288

(57) ABSTRACT

A method and system are described for generating structured relations between words in sentences. The method includes generating encoded hidden state vectors using a single layer bi-directional Long Short Term Memory (LSTM) neural network. The method includes generating current hidden state vectors based on word embedding associated with each word at a time stamp ‘t’. The method includes computing attention distribution of each word based on encoded hidden state vectors and current hidden state vectors. The method includes computing context vector of sentences based on attention distribution of each word and the encoded hidden state vectors. The method includes computing vocabulary distribution at time stamp “t” based on context vector and current hidden state vectors. The method includes computing probability distribution of words based on encoded hidden state vectors, current hidden state vectors, and vocabulary distribution. The method includes generating plurality of structured relations between words based on probability distribution.

This application claims the benefit of Indian Patent Application Serial No. 201941009036, filed Mar. 8, 2019, which is hereby incorporated by reference in its entirety.

### FIELD

The present subject matter is related, in general to natural language processing, and more particularly, but not exclusively to a method and system for generating a plurality of structured relations between a plurality of words in a plurality of sentences.

### BACKGROUND

Generally, structured information refers to information, whose intended meaning may be represented in structure or format of the data. Further, unstructured information refers to information, whose intended meaning requires interpretation in order to approximate and extract the meaning of the information. Few of the examples of unstructured data include natural language documents, speech, audio, images, video, or the like. Information extraction is one of the major problem of Natural Language Processing (NLP) and one of the important problem in information extraction is the extraction of entities from text documents and the extraction of relations among the entities.

Conventionally, there are various techniques available for extracting the entities from the text documents and the extraction of relation between the entities. Most of the conventional mechanisms work with a single sentence and generate a single relationship between a pair of entities. The generated single relation is useful however, existing techniques fail to generate multiple relations between the same pair of entities simultaneously.

The conventional mechanisms for extraction of multiple entities from text or sentences are based on sentence semantics and considers different entities in a same way causing ambiguity. For example, consider two sentences “Ankit is a citizen of India” and “Ankit is a citizen of Bangalore”, in this case, both will generate same relation i.e. citizenship. However, existing mechanisms fail to generate a relation between the entity “India” and “Bangalore”. The technical challenge involved here is that conventional mechanisms only consider sentence semantics and do not take into consideration other factors for generating the relationship between entities. Further, the connection considered between the sentences is not considered to generate relations between the same entities in other sentences. Thus, in conventional systems each entity in each sentence is considered independent of each other and thus multiple relations between the same entities in different sentences are not generated, which leads to inaccurate generation of structured data and further the extracted structured data may not be effectively used for further analysis, processing, better insights and decision making.

Additionally, the conventional mechanisms extract the relations from single limited length sentences, which limits the accuracy and efficiency of such systems. Further, the conventional mechanisms use word embeddings of all the vocabulary words for extracting the relation. Due to the limited size of the vocabulary, all non-vocabulary words (example: numbers) are treated in a same way by an unknown embedding. In addition, the words, which appear less frequently, will have poor embedding. Such words having poor embedding are clustered together with unrelated words and it makes the network very painful to reproduce such words at the output, leading to loss of information and thus inaccuracy in extracting the relations.

Further, conventional mechanisms support only one relation extraction and non-vocabulary (numeric) inputs are not taken into account while generating the relation. Further, the conventional mechanisms do not differentiate between the named entities for which the relations are extracted. Also, the conventional mechanisms do not take into account the domain specific entities that are out of vocabulary entities for generating the relations.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

According to embodiments illustrated herein, there may be provided a method for generating a plurality of structured relations between a plurality of words in a plurality of sentences. The method may include receiving a plurality of sentences comprising a plurality of words. In an embodiment, the plurality of sentences may comprise numerical data and textual data. The method may include generating a plurality of encoded hidden state vectors associated with the plurality of sentences using a single layer bi-directional Long Short Term Memory (LSTM) neural network. The method may include generating a plurality of current hidden state vectors based on word embedding associated with each word in the plurality of sentences at a time stamp ‘t’. The method may include computing an attention distribution of each word in the plurality of sentences based on the plurality of encoded hidden state vectors and plurality of current hidden state vectors. In an embodiment, the attention distribution is indicative of importance of each word in the plurality of sentences. The method may include computing a context vector of the plurality of sentences based on the attention distribution of each word in the plurality of sentences and the plurality of encoded hidden state vectors. The method may include computing a vocabulary distribution at the time stamp “t” based on the context vector and the plurality of current hidden state vectors. The method may include computing a probability distribution of each of the plurality of words in the plurality of sentences based on the plurality of encoded hidden state vectors, the plurality of current hidden state vectors, and the vocabulary distribution. The method may include generating an output comprising a plurality of structured relations between the plurality of words based on the probability distribution. The method may include rendering a knowledge graph depicting the plurality of structured relations between the plurality of words.

According to embodiments illustrated herein, there may be provided an application server to generate a plurality of structured relations between a plurality of words in a plurality of sentences. The application server may comprise a processor and a memory communicatively coupled to the processor. The memory stores processor instructions, which, on execution, causes the processor to receive a plurality of sentences comprising a plurality of words. In an embodiment, the plurality of sentences comprises numerical data and textual data. The processor may be further configured to generate a plurality of encoded hidden state vectors associated with the plurality of sentences using a single layer bi-directional Long Short Term Memory (LSTM) neural network.

The processor may be further configured to generate a plurality of current hidden state vectors based on word embedding associated with each word in the plurality of sentences at a time stamp ‘t’. The processor may be further configured to compute an attention distribution of each word in the plurality of sentences based on the plurality of encoded hidden state vectors and plurality of current hidden state vectors. In an embodiment, the attention distribution is indicative of importance of each word in the plurality of sentences. The processor may be further configured to compute a context vector of the plurality of sentences based on the attention distribution of each word in the plurality of sentences and the plurality of encoded hidden state vectors. The processor may be further configured to compute a vocabulary distribution at the time stamp “t” based on the context vector and the plurality of current hidden state vectors. The processor may be further configured to compute a probability distribution of each of the plurality of words in the plurality of sentences based on the plurality of encoded hidden state vectors, the plurality of current hidden state vectors, and the vocabulary distribution. The processor may be further configured to generate an output comprising a plurality of structured relations between the plurality of words based on the probability distribution. The processor may be further configured to render a knowledge graph depicting the plurality of structured relations between the plurality of words.

According to embodiments illustrated herein, a non-transitory computer-readable storage medium having stored thereon, a set of computer-executable instructions for causing a computer comprising one or more processors to perform steps of generating a plurality of structured relations between a plurality of words in a plurality of sentences. The one or more processors may be configured to receive a plurality of sentences comprising a plurality of words. In an embodiment, the plurality of sentences comprises numerical data and textual data. The one or more processors may be configured to generate a plurality of encoded hidden state vectors associated with the plurality of sentences using a single layer bi-directional Long Short Term Memory (LSTM) neural network. The one or more processors may be configured to generate a plurality of current hidden state vectors based on word embedding associated with each word in the plurality of sentences at a time stamp ‘t’. The one or more processors may be configured to compute an attention distribution of each word in the plurality of sentences based on the plurality of encoded hidden state vectors and plurality of current hidden state vectors. In an embodiment, the attention distribution is indicative of importance of each word in the plurality of sentences. The one or more processors may be configured to compute a context vector of the plurality of sentences based on the attention distribution of each word in the plurality of sentences and the plurality of encoded hidden state vectors. The one or more processors may be configured to compute a vocabulary distribution at the time stamp “t” based on the context vector and the plurality of current hidden state vectors. The one or more processors may be configured to compute a probability distribution of each of the plurality of words in the plurality of sentences based on the plurality of encoded hidden state vectors, the plurality of current hidden state vectors, and the vocabulary distribution. The one or more processors may be configured to generate an output comprising a plurality of structured relations between the plurality of words based on the probability distribution. The one or more processors may be configured to render a knowledge graph depicting the plurality of structured relations between the plurality of words.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 is a block diagram that illustrates a system environment in which various embodiments of the method and the system may be implemented;

FIG. 2 is a block diagram that illustrates an application server configured for generating a plurality of structured relations between a plurality of words in a plurality of sentences, in accordance with some embodiments of the present disclosure;

FIG. 3A illustrates a knowledge graph that depicts the plurality of structured relations between the plurality of words, in accordance with some embodiments of the present disclosure;

FIG. 3B illustrates a table that depicts the plurality of structured relations between the plurality of words, in accordance with some embodiments of the present disclosure;

FIG. 4 is a flowchart illustrating a method for generating a plurality of structured relations between a plurality of words in a plurality of sentences, in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The disclosed system and method may generate structured relations between a plurality of words from a plurality of sentences in documents. In an embodiment, multiple relations may be extracted between a plurality of words from a set of unstructured text data. In an embodiment, the relations and corresponding entities may be detected automatically from a new unstructured text input. In an embodiment, a plurality of relations may be generated between the plurality of words simultaneously so that a better knowledge graph may be generated which may provide better insights and decision making. In an embodiment, the disclosed method and system addresses ambiguity due to words in the sentences that are beyond vocabulary.

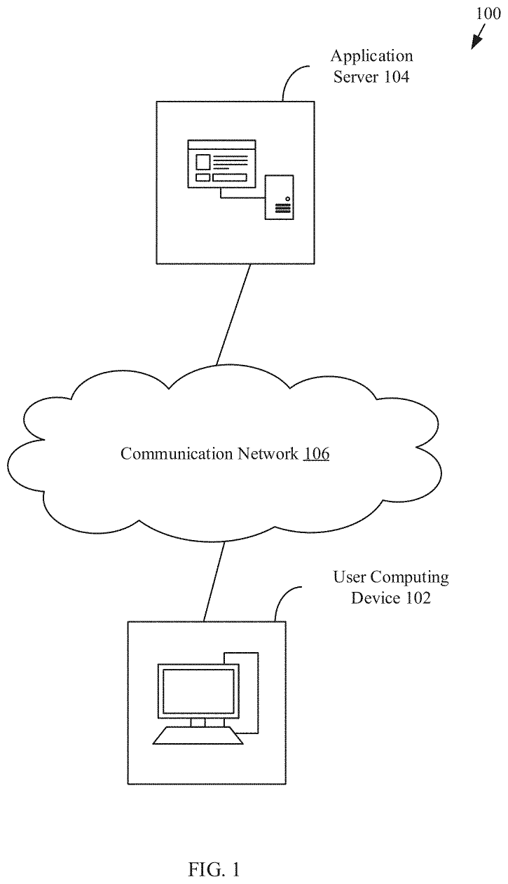

FIG. 1 is a block diagram that illustrates a system environment 100 in which various embodiments of the method and the system may be implemented. The system environment 100 may include a user computing device 102, an application server 104, and a communication network 106. The user computing device 102 and the application server 104 may be communicatively coupled to each other via the communication network 106.

In an embodiment, the user computing device 102 may be configured for receiving a query for extracting a plurality of relations from unstructured data. The unstructured data may comprise a plurality of words in a plurality of sentences. The user computing device 102 may be configured for annotating the plurality of words in the plurality of sentences. For example, the user computing device 102 may identify the subject, verb and object in each sentence and then further annotate each subject and object as an entity in the plurality of sentences. In an embodiment, the user computing device 102 may be configured for transmitting the annotated plurality of words to the application server 104 for generating a plurality of structured relations between a plurality of words in a plurality of sentences.

In an embodiment, the plurality of words may also be referred to as a plurality of entities. The term “entity” herein refers, but not limited, to an object, item, person, place, value, concept, and the like. For example, consider a sentence “Sam is a citizen of India”, in this case, both “Sam” and “India” can act as entities, such entities are bring referred to as the plurality of words. The term “Relation” herein refers, but not limited, to the information or data that connects two or more entities/plurality of words. In the above example, “Sam” and “India” are connected by citizen relationship.

In an embodiment, the application server 104 may refer to a computing device or a software framework hosting an application or a software service. In an embodiment, the application server 104 may be implemented to execute procedures such as, but not limited to, programs, routines, or scripts stored in one or more memories for supporting the hosted application or the software service. In an embodiment, the hosted application or the software service may be configured to perform one or more predetermined operations. The application server 104 may be realized through various types of application servers such as, but are not limited to, a Java application server, a .NET framework application server, a Base4 application server, a PHP framework application server, or any other application server framework.

In an embodiment, the application server 108 may be configured to receive the plurality of sentences comprising the annotated plurality of words from the user computing device 102. In an embodiment, the plurality of sentences may include numerical data and textual data. In an embodiment, the plurality of words in the plurality of sentences correspond to plurality of annotated entities. The application server 108 may be configured to generate a plurality of encoded hidden state vectors associated with the plurality of sentences using a single layer bi-directional Long Short Term Memory (LSTM) neural network. The application server 108 may be configured to generate a plurality of current hidden state vectors based on word embedding associated with each word in the plurality of sentences at a time stamp ‘t’. The application server 108 may be configured to compute an attention distribution of each word in the plurality of sentences based on the plurality of encoded hidden state vectors and plurality of current hidden state vectors. In an embodiment, the attention distribution is indicative of importance of each word in the plurality of sentences.

The application server 108 may be configured to compute a context vector of the plurality of sentences based on the attention distribution of each word in the plurality of sentences and the plurality of encoded hidden state vectors. The application server 108 may be configured to compute a vocabulary distribution at the time stamp “t” based on the context vector and the plurality of current hidden state vectors. The application server 108 may be configured to compute a probability distribution of each of the plurality of words in the plurality of sentences based on the plurality of encoded hidden state vectors, the plurality of current hidden state vectors, and the vocabulary distribution. The application server 108 may be configured to generate an output comprising a plurality of structured relations between the plurality of words based on the probability distribution.

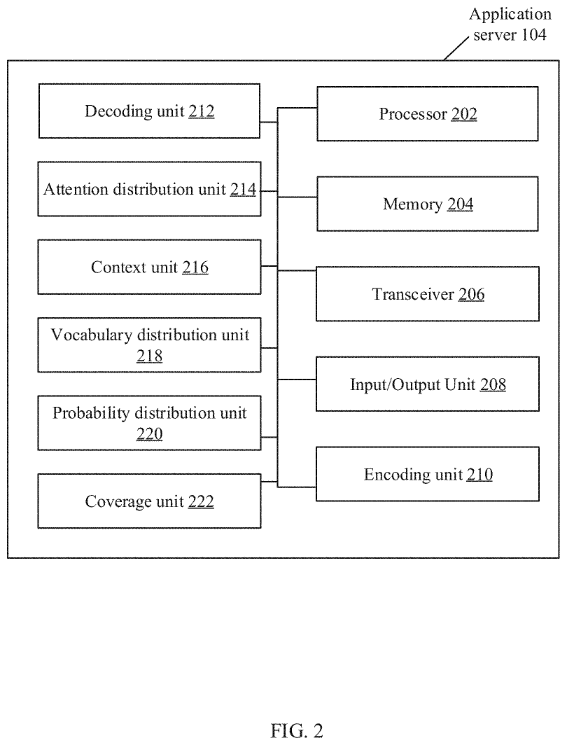

The application server 108 may be configured to render a knowledge graph depicting the plurality of structured relations between the plurality of words. The application server 108 may be configured to compute a coverage vector based on the probability distribution and the attention distribution. In an embodiment, the coverage vector avoids duplicate generation of relations within the generated plurality of structured relations The application server 108 may be configured to selecting one of: generation of structured relations or sampling of the plurality of words from the plurality of sentences based on the probability distribution. The operation of the application server 104 has been discussed later in conjunction with FIG. 2.

In an embodiment, the communication network 106 may correspond to a communication medium through which the user computing device 102 and the application server 104 may communicate with each other. Such a communication may be performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 106 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

A person having ordinary skill in the art will appreciate that the scope of the disclosure is not limited to realizing the application server 104 and the user computing device 102 as separate entities. In an embodiment, the application server 104 may be realized as an application program installed on and/or running on the user computing device 102 without departing from the scope of the disclosure.

FIG. 2 is a block diagram that illustrates an application server 104 configured for generating a plurality of structured relations between a plurality of words in a plurality of sentences, in accordance with some embodiments of the present disclosure.

The application server 104 further includes a processor 202, a memory 204, a transceiver 206, an input/output unit 208, an encoding unit 210, a decoding unit 212, an attention distribution unit 214, a context unit 216, a vocabulary distribution unit 218, a probability distribution unit 220, and a coverage unit 222. The processor 202 and the memory 204 may further be communicatively coupled to the transceiver 206, the input/output unit 208, the encoding unit 210, the decoding unit 212, the attention distribution unit 214, the context unit 216, the vocabulary distribution unit 218, the probability distribution unit 220, and the coverage unit 222.

The processor 202 includes suitable logic, circuitry, interfaces, and/or code that may be configured to execute a set of instructions stored in the memory 204. The processor 202 may be implemented based on a number of processor technologies known in the art. Examples of the processor 202 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory 204 includes suitable logic, circuitry, interfaces, and/or code that may be configured to store the set of instructions, which may be executed by the processor 202. In an embodiment, the memory 204 may be configured to store one or more programs, routines, or scripts that may be executed in coordination with the processor 202. The memory 204 may be implemented based on a Random Access Memory (RAM), a Read-Only Memory (ROM), a Hard Disk Drive (HDD), a storage server, and/or a Secure Digital (SD) card.

The transceiver 206 includes of suitable logic, circuitry, interfaces, and/or code that may be configured to receive the plurality of sentences comprising the plurality of annotated words from the user computing device 102, via the communication network 106. The transceiver 206 may be further configured to transmit the generated output comprising the plurality of structured relations to the user computing device 102. The transceiver 206 may implement one or more known technologies to support wired or wireless communication with the communication network. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The Input/Output (I/O) unit 208 includes suitable logic, circuitry, interfaces, and/or code that may be configured to receive an input or transmit an output. The input/output unit 210 comprises of various input and output devices that are configured to communicate with the processor 202. Examples of the input devices include, but are not limited to, a keyboard, a mouse, a joystick, a touch screen, a microphone, and/or a docking station. Examples of the output devices include, but are not limited to, a display screen and/or a speaker. In an embodiment, the Input/Output (I/O) unit 208 may be configured to render or display a knowledge graph depicting the plurality of structured relations between the plurality of words.

The encoding unit 210 includes suitable logic, circuitry, interfaces, and/or code that may be configured to generate a plurality of encoded hidden state vectors associated with the plurality of sentences using a single layer bi-directional Long Short Term Memory (LSTM) neural network. In an embodiment, the encoding unit 210 receives the annotated plurality of words from the transceiver 206 as a high dimensional embedded vector to generate the plurality of encoded hidden state vectors in a new transformed space. In an embodiment, the plurality of encoded hidden state vectors may also be referred to as feature vectors or a tensor in the new transformed space. In an embodiment, the plurality of encoded hidden state vectors shows a compact representation of word embeddings associated with each of the annotated plurality of words.

The decoding unit 212 includes suitable logic, circuitry, interfaces, and/or code that may be configured to generate a plurality of current hidden state vectors based on word embedding associated with each word in the plurality of sentences at a time stamp ‘t’. In an embodiment, the plurality of current hidden state vectors is used to generate a plurality of output words that is indicative of mapping of the plurality of words in the plurality of sentence. In an embodiment, the decoding unit 212 may receive the plurality of encoded hidden state vectors from the encoding unit 210 and the plurality of encoded hidden state vectors may be mapped back with the word embeddings to recreate the input of significant words from the plurality of words. Thus, the decoding unit 212 identifies most significant words i.e. the plurality of output words from the plurality of words in the plurality of sentences that contribute to the reconstruction of the plurality of words.

The attention distribution unit 214 includes suitable logic, circuitry, interfaces, and/or code that may be configured to compute an attention distribution of each word in the plurality of sentences based on the plurality of encoded hidden state vectors and plurality of current hidden state vectors. In an embodiment, the attention distribution may also be dependent on the word embedding of each of the plurality of words. In an embodiment, the attention distribution is indicative of importance of each word in the plurality of sentences. In an embodiment, the attention distribution unit 214 may also provide an indication of where to look to find the next word.

Further, the attention distribution unit 214 may be configured to implement a shallow neural network with one layer. The attention distribution unit 214 may be configured to generate an indication, using the shallow neural network with one layer, including when to copy words from the input text i.e. the plurality of words and when to generate the words at an output time. In an embodiment, the attention distribution unit 214 may be configured to send the generated indication to the probability distribution unit 220.

The context unit 216 includes suitable logic, circuitry, interfaces, and/or code that may be configured to compute a context vector of the plurality of sentences based on the attention distribution of each word in the plurality of sentences and the plurality of encoded hidden state vectors. In an embodiment, the context vector may be a weighted sum between the attention distribution and the plurality of encoded hidden state vectors. In an embodiment, the context vector is further concatenated with the plurality of current hidden state vectors at the time stamp “t”. In an embodiment, the context vector may be considered as a representation of the input i.e. the plurality of input words.

The vocabulary distribution unit 218 includes suitable logic, circuitry, interfaces, and/or code that may be configured to compute a vocabulary distribution at the time stamp “t” based on the context vector and the plurality of current hidden state vectors. In an embodiment, vocabulary distribution refers to a distribution, which helps relation extraction to generate the name of the relation in the output.

The probability distribution 220 includes suitable logic, circuitry, interfaces, and/or code that may be configured to compute a probability distribution of each of the plurality of words in the plurality of sentences based on the plurality of encoded hidden state vectors, the plurality of current hidden state vectors, and the vocabulary distribution. The probability distribution 220 may be configured to generate an output comprising a plurality of structured relations between the plurality of words based on the probability distribution. The probability distribution 220 may be further configured to selecting one of: generation of structured relations or sampling of the plurality of words from the plurality of sentences based on the probability distribution.

In an embodiment, the probability distribution unit 220 may be configured to receive the generated indication, using the shallow neural network with one layer, that indicates when to copy words from the input text i.e. the plurality of words and when to generate the words at an output time. In an embodiment, the probability distribution includes a pointer mechanism to control when to generate a new relation or to copy the received words to the output based on the received indication. In an embodiment, the probability distribution is further indicative of a location of a word in the plurality of sentences. In an embodiment, based on the pointer mechanism words in the plurality of sentences are directly copied from the received plurality of sentences to the output, and the output is independent of an output length. The probability distribution unit 220 may be configured to implement a modified pointer neural network that extracts a plurality of relations between the plurality of words without providing the output length, thus making the process independent of the output length.

The modified pointer neural network is a neural network architecture, which may be configured to learn conditional probability of a discrete output sequence with elements that are discrete tokens corresponding to position in an input sequences. In addition, modified pointer neural network may have variable length output sequences depending on the input sequences, which is not possible in a conventional encoder-decoder architecture where the output length is fixed.

In an implementation, the probability distribution unit 220 may configure the modified pointer neural network to extract plurality of relations existing between the plurality of words (different entities) in the plurality of sentences (input sequence) without giving the output length a prior, as the input text i.e. the plurality of sentences includes variable number of relations between the plurality of words i.e. entities. In an embodiment, the probability distribution unit 220 may configure the modified pointer neural network to copy one or more words from the plurality of sentences (input sequence) directly to the output. Such one or more copied words may refer to the entities that may not have strong word embedding vectors and are usually out of vocabulary words or rare words. Further, the probability distribution unit 220 may be configured to render the extracted plurality of relations to a user. In an embodiment, the probability distribution unit 220 may be configured to send the extracted plurality of relations to the transceiver 206 and then further to the user computing device 102.

The coverage unit 222 includes suitable logic, circuitry, interfaces, and/or code that may be configured to compute a coverage vector based on the probability distribution and the attention distribution. In an embodiment, the coverage vector avoids duplicate generation of relations within the generated plurality of structured relations. In an embodiment, the output generated by the coverage unit 222 is sent to the attention distribution unit 214, which may be used for further processing in the next time instance.

In operation, the transceiver 206 may be configured to receive the annotated plurality of words from the user computing device 102 for generating the plurality of structured relations between the plurality of words in the plurality of sentences. The annotated words in the plurality of sentences identify each of the entities in the plurality of sentences. An example of the identified entities in the sentences may be as follows: Iniesta (entity-1) is a Spanish (entity-2) footballer. Iniesta (entity-3) plays for club Barcelona (entity-4). Barcelona (entity-5) belongs to Catalonia (entity-6) community in Spain. Such annotated words in the plurality of sentences may be provided as input to the application server 104 for generating the plurality of structured relations.

After the transceiver 206 receives the annotated plurality of words from the user computing device 102, the encoding unit 210 may be configured to generate a plurality of encoded hidden state vectors associated with the plurality of sentences using a single layer bi-directional Long Short Term Memory (LSTM) neural network. In an embodiment, the encoding unit 210 may receive each word of the plurality of words from input text i.e. the plurality of sentences sequentially. The input text herein refers, but not limited, to the sentence input with known entities.

The encoding unit 210 encodes the high dimensional embedded vector to generate the plurality of encoded hidden state vectors in a new transformed space. In an embodiment, the plurality of encoded hidden state vectors may also be referred to as feature vectors or a tensor in the new transformed space. In an embodiment, the plurality of encoded hidden state vectors shows a compact representation of word embeddings associated with each of the annotated plurality of words.

After generation of the plurality of encoded hidden state vectors, the decoding unit 212 may receive the word embedding of previous word on each time stamp “t” from the encoding unit 210. In an embodiment, the decoding unit 212 may be configured to implement a single layer uni-directional LSTM. The decoding unit 212 may configure the single layer uni-directional LSTM to generate the plurality of current hidden state vectors based on the word embedding associated with each word in the plurality of sentences at a time stamp ‘t’. In an embodiment, the plurality of current hidden state vectors is used to generate a plurality of output words that is indicative of mapping of the plurality of words in the plurality of sentence. In an embodiment, the decoding unit 212 may receive the plurality of encoded hidden state vectors from the encoding unit 210 and the plurality of encoded hidden state vectors may be mapped back with the word embeddings to recreate the input of significant words from the plurality of words. Thus, the decoding unit 212 identifies most significant words i.e. the plurality of output words from the plurality of words in the plurality of sentences that contribute to the reconstruction of the plurality of words. In an embodiment, in the next time instance, such as t1, apart from the current sequence of hidden state vectors, the decoding unit 212 may also receive the previous hidden state as the input.

After the generation of the plurality of current hidden state vectors, the attention distribution unit 214 may compute the attention distribution of each word in the plurality of sentences based on the plurality of encoded hidden state vectors and plurality of current hidden state vectors. In an embodiment, the attention distribution may also be dependent on the word embedding of each of the plurality of words. In an embodiment, the attention distribution is indicative of importance of each word in the plurality of sentences. In an embodiment, the attention distribution unit 214 may also provide an indication of where to look to find the next word.

For instance, by using the plurality of encoded hidden state vectors “hᵢ” received from the encoding unit 210 and the plurality of current hidden state vectors “sₜ” received from the decoding unit 212, the attention distribution “a^{t}” may be expressed as below:

eᵢ^{t}=v^{t}tanh(wₕ hᵢ+wₛsₜ+bₐₜₜₑₙ) a^{t}=softmax(eᵢ^{t})

Where, Wₕ, wₛ, vₜ, bₐₜₜₑₙ are learning parameters and eᵢ^{t} is an intermediate attention vector which is also a learning parameter for calculating the attention distribution.

a^{t}=attention distribution

A person having ordinary skill in the art will appreciate that the scope of the disclosure is not limited to computing the attention distribution using the aforementioned learning parameters. In an embodiment, one or more learning parameters apart from those mentioned herein may be utilized to compute the attention distribution without departing from the scope of the disclosure.

Further, the attention distribution unit 214 may be configured to implement a shallow neural network with one layer. The attention distribution unit 214 may be configured to generate an indication, using the shallow neural network with one layer, including when to copy words from the input text i.e. the plurality of words and when to generate the words at an output time. In an embodiment, the attention distribution unit 214 may be configured to send the generated indication to the probability distribution unit 220.

After computing the attention distribution, the attention distribution may be sent to the coverage unit 222. The coverage unit 222 may be configured to compute a coverage vector based on the probability distribution and the attention distribution. In an embodiment, the coverage vector avoids duplicate generation of relations within the generated plurality of structured relations. In an embodiment, the output generated by the coverage unit 222 is sent to the attention distribution unit 214, which may be used for further processing in the next time instance. Typically, when a relation is generated in one instance then there is a possibility that the same relation may be generated in another instance. In order to avoid this repetition problem, a modified coverage mechanism is implemented by the coverage unit 222. In order to compute the coverage vector, the attention distribution plays an important role in producing the output. In an embodiment, the coverage vector may be expressed as the summation of all previous attention distribution ‘a^{t}’ and the probability distribution ‘a_{copy}’.

cₜ=Σₜ₌₀^{t-1}0.4 aₜ+0.8a_{copy}_{ₜ}

A person having ordinary skill in the art will appreciate that the scope of the disclosure is not limited to computing the coverage vector using the aforementioned parameters. In an embodiment, one or more parameters apart from those mentioned herein may be utilized to compute the coverage vector without departing from the scope of the disclosure.

Intuitively, the coverage vector cₜ is a distribution, which indicates the degree of coverage, which means that the relation is already extracted between the entities from the input text. To avoid repetition problem, the term cₜ is included in computation of the attention distribution. cₜ can be interpreted as small summary of what has been generated. Based on the coverage vector, added information provides low probability score to already generated entity-relation triplet words. This helps in avoiding the generation of same entity relation triplets repeatedly. In an embodiment, the coverage vector may be fed as an extra input to compute the attention distribution. For example, the below expression shows how cₜ is fed to compute the attention distribution:

eᵢ^{t}=v^{t}tanh(wₕ hᵢ+wₛsₜ+w_{c}cₜ+bₐₜₜₑₙ) a^{t}=softmax(eᵢ^{t})

Where, wₕ, wₛ, w_{c}, vₜ, bₐₜₜₑₙ are learning parameters
a=attention distribution

A person having ordinary skill in the art will appreciate that the scope of the disclosure is not limited to computing the attention distribution using the aforementioned learning parameters. In an embodiment, one or more learning parameters apart from those mentioned herein may be utilized to compute the attention distribution without departing from the scope of the disclosure.

After computation of the coverage vector and the attention distribution, the context unit 216 may compute a context vector of the plurality of sentences based on the attention distribution of each word in the plurality of sentences and the plurality of encoded hidden state vectors. In an embodiment, the context vector may be a weighted sum between the attention distribution and the plurality of encoded hidden state vectors. In an embodiment, the context vector is further concatenated with the plurality of current hidden state vectors at the time stamp “t”. In an embodiment, the context vector may be considered as a representation of the input i.e. the plurality of input words. In an embodiment, the context vector \dot{h}ₗ may be represented by the equation below:

\dot{h}ₗ=Σᵢ aᵢ^{t} hᵢ

Where, “hᵢ” indicates i^{th} encoded hidden state vector, “i” being the index of the word in the input text.

A person having ordinary skill in the art will appreciate that the scope of the disclosure is not limited to computing the context vector using the aforementioned parameters. In an embodiment, one or more parameters apart from those mentioned herein may be utilized to compute the context vector without departing from the scope of the disclosure.

After computing the context vector, the vocabulary distribution unit 218 may be configured to compute a vocabulary distribution at the time stamp “t” based on the context vector and the plurality of current hidden state vectors. In an embodiment, the vocabulary distribution refers to a distribution, which helps relation extraction to generate the name of the relation in the output. In an embodiment, the context vector may indicate the information regarding “What has been read from the input text, and is concatenated with the plurality of current hidden state vectors of the decoding unit at time stamp “t”, which is fed to single layers of temporal convolution neural network (conv1D) to compute the vocabulary distribution. The vocabulary distribution may be used to generate the output word that includes relation between the entities such as “occupation”, “citizenship” and the like. In an embodiment, the vocabulary distribution p_{vocab}. may be represented by the equation below:

p_{vocab}=conv1D([\dot{h}ₜ:sₜ])

A person having ordinary skill in the art will appreciate that the scope of the disclosure is not limited to computing the vocabulary distribution using the aforementioned parameters. In an embodiment, one or more parameters apart from those mentioned herein may be utilized to compute the vocabulary distribution without departing from the scope of the disclosure.

After computing the vocabulary distribution, the probability distribution unit 220 may be configured to compute a probability distribution to select between generation of relations or sampling of words from the plurality of words. The probability distribution unit 220 may receive an indication that indicates when to copy words from the input text i.e. the plurality of words and when to generate the relations between the words at an output time. The probability distribution indicates the probability of each word based on which the words can be copied from the input to the output. The probability distribution unit 220 may be configured to implement a shallow neural network with one layer that may receive the plurality of encoded hidden state vectors hₜ from the encoding unit, the plurality of current hidden state vectors sₜ from the decoding unit and the word embedding of the current word xₜ to generate an output of either “0” or “1”. If value is “0” then copy from input text and if the value is 1then generate relation. If w is a set of name of relation then p_{switch} is one, if w is set name of entity which means it is copied from input sequence so in that case p_{switch} zero. The output of the shallow neural network with one layer may be represented using the below equation:

p_{switch}=σ(wₕ_{ₗ}^{T} hₗ+wₛ_{ₜ}^{T} sₜ+wₓ_{ᵢ}^{T}xₜ+b_{switch})

Where, xₜ is input word at time stamp ‘t’, w_{\dot{h}}_{ₗ}^{T}, wₛ_{ₜ}^{T}, wₓ_{ᵢ}^{T}, b_{switch} are learning parameters and p_{switch} is switching unit output.

A person having ordinary skill in the art will appreciate that the scope of the disclosure is not limited to the learning parameters that have been described herein. In an embodiment, one or more learning parameters apart from the parameters mentioned herein may be utilized without departing from the scope of the disclosure.

After determining the output of either “0” or “1” from the shallow neural network, probability distribution unit 220 may be configured to generate the plurality of structured relations between the plurality of words using the modified pointer neural network. In an embodiment, the probability distribution unit 220 may be configured to receive the generated indication, using the shallow neural network with one layer, that indicates when to copy words from the input text i.e. the plurality of words and when to generate the words at an output time. In an embodiment, the probability distribution includes a pointer mechanism to control when to generate a new relation or to copy the received words to the output based on the received indication. In an embodiment, the probability distribution is further indicative of a location of a word in the plurality of sentences. In an embodiment, based on the pointer mechanism words in the plurality of sentences are directly copied from the received plurality of sentences to the output, and the output is independent of an output length. The probability distribution unit 220 may be configured to implement a modified pointer neural network that extracts a plurality of relations between the plurality of words without providing the output length, thus making the process independent of the output length. The probability distribution includes a pointer mechanism i.e. the modified pointer neural network to control when to generate a new relation or to copy the received words to the output. In an embodiment, the probability distribution is further indicative of a location of a word in the plurality of sentences. In an embodiment, based on the pointer mechanism words in the plurality of sentences are directly copied from the received plurality of sentences to the output, and the output is independent of an output length.

The modified pointer neural network utilizes the output p_{switch} as soft switch to select between generating words using the vocabulary distribution p_{switch} and sampling a word from the probability distribution. The modified pointer neural network is a neural network architecture, which may be configured to learn conditional probability of a discrete output sequence with elements that are discrete tokens corresponding to position in an input sequences. In addition, modified pointer neural network may have variable length output sequences depending on the input sequences, which is not possible in a conventional encoder-decoder architecture where the output length is fixed.

In an implementation, the probability distribution unit 220 may configure the modified pointer neural network to extract plurality of relations existing between the plurality of words (different entities) in the plurality of sentences (input sequence) without giving the output length a prior, as the input text i.e. the plurality of sentences includes variable number of relations between the plurality of words i.e. entities. In an embodiment, the probability distribution unit 220 may configure the modified pointer neural network to copy one or more words from the plurality of sentences (input sequence) directly to the output. Such one or more copied words may refer to the entities that may not have strong word embedding vectors and are usually out of vocabulary words or rare words.

The output of the switch network unit p_{switch} is used as soft switch to select between generating words using the vocabulary distribution p_{svocab} and sampling a word from the probability distribution using the modified pointer network mechanism. The probability distribution unit 220 may be configured to compute a probability distribution of each of the plurality of words in the plurality of sentences based on the plurality of encoded hidden state vectors, the plurality of current hidden state vectors, and the vocabulary distribution. The probability distribution may be computed using the below equation:

eᵢ^{t}=v^{t}tanh(wₕhᵢ+wₓsₜ) a_{copy}^{t}=softmax(eᵢ^{t}) \acute{s}=Σᵢ₌₁ⁿ a_{copy}_{ᵢ}^{t} hᵢ p(w)=softmax((1-p_{switch})w_{d}([s:\acute{s}]p_{switch}p_{vocab})

Where Wd: is the learning parameter and Wd: is a weighted matrix

A person having ordinary skill in the art will appreciate that the scope of the disclosure is not limited to the one or more parameters that have been described herein. In an embodiment, one or more parameters apart from those mentioned herein may be utilized to compute the probability distribution without departing from the scope of the disclosure.

In one implementation, for each input sequence i.e. the plurality of words in the plurality of sentences, let the extended vocabulary denotes the union of all the plurality of words and name of the relation including some additional tokens. The probability distribution unit 220 may be configured to obtain the above probability distribution over the extended vocabulary. If w is a set of name of relation then p_{switch} is one, if w is set name of entity which means it is copied from input sequence so in that case p_{switch} is zero. Thus, based on the probability distribution that is computed using the above equation, the probability distribution unit 220 may generate the plurality of structured relations between the plurality of words using the modified pointer neural network. The modified pointer neural network ensures that plurality of relations is extracted between the plurality of words and the coverage vector avoids duplicate generation of relations within the generated plurality of structured relations.

In an embodiment, after the plurality of relations is extracted, then the input/output unit may be configured to render the extracted plurality of relations to a user. In an embodiment, the probability distribution unit 220 may be configured to send the extracted plurality of relations to the transceiver 206 and then further to the user computing device 102. The user computing device 102 may then render the extracted plurality of relations to the user.

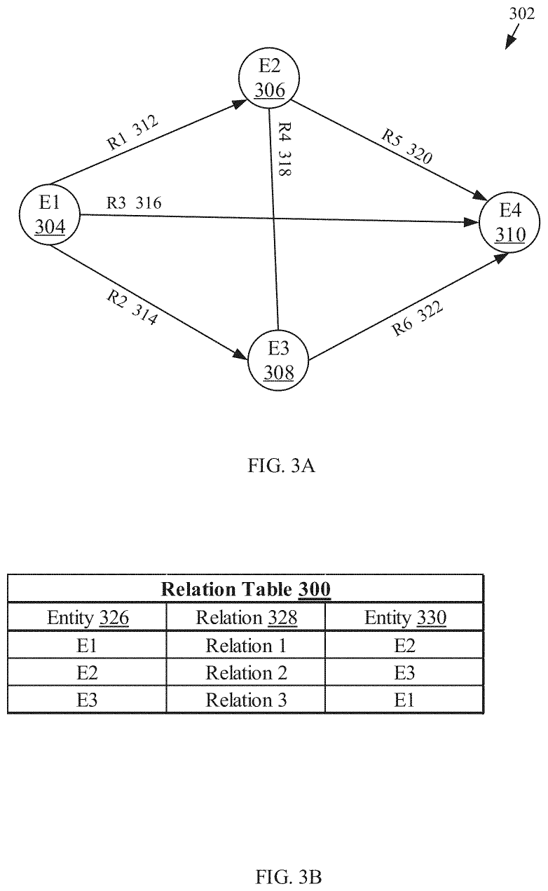

FIG. 3A illustrates a knowledge graph 302 that depicts the plurality of structured relations between the plurality of words, in accordance with some embodiments of the present disclosure. In an embodiment, the structured relation between the entities may be represented in the form of a knowledge graph 302, as shown in FIG. 3A, to the user. As shown in FIG. 3A, entities E1, E2, E3, and E4 are represented using 304, 306, 308, and 310. Further, the relationship between E1 and E2 is shown by R1 312, the relationship between E1 and E3 is shown by R2 314, the relationship between E1 and E4 is shown by R3 316, the relationship between E2 and E3 is shown by R4 318, the relationship between E2 and E4 is shown by R5 320, and the relationship between E3 and E4 is shown by R6 322.

FIG. 3B illustrates a table 300 that depicts the plurality of structured relations between the plurality of words, in accordance with some embodiments of the present disclosure. In another embodiment, the structured relation between the entities may be represented in the form of a table 324, as shown in FIG. 3B, to the user. As shown in FIG. 3B, column 326 and column 330 indicates the entity names and the column 328 indicates the relations between the corresponding entities. Thus, as shown in FIG. 3B, entity E1 and entity E2 have Relation 1, similarly entity E2 and entity E3 have Relation 2, and similarly entity E3 and entity E1 have Relation 3.

In an exemplary implementation, plurality of text sentences is taken as input to generate the knowledge graph. Generating plurality of relations together is helpful in generating better knowledge graph. For example, “Sam lives in Delhi” and “Delhi is the capital of India”. If the relations are extracted separately between entities “Sam”, “Delhi” and “India” it is difficult or requires additional computation to conclude that “Sam” is a citizen of “India”. However, probability distribution unit 220 which implements the modified pointer neural network extracts multiple relations between the same entities. Thus, 4 relations between 3 entities are generated simultaneously by the probability distribution unit 220 which are independent of the output length. The conventional systems would have generated only the Relation 1 and Relation 2 mentioned below. The disclosed method and system generate the below 4 relations.

Relation 1: The relation of “living” between “Sam” and “Delhi”

Relation 2: The relation of “capital” between “Delhi” and “India”

Relation 3: The relation of “citizenship” between “Sam” and “India”

Relation 4: The relation of “living” between “Sam” and “India”

In another exemplary implementation, consider that the input text includes “BORN IN HAWAII, OBAMA IS A US CITIZEN”. The input text is provided as input to the encoding unit. The encoding unit may generate the plurality of encoded hidden state vectors associated with the plurality of sentences using a single layer bi-directional Long Short Term Memory (LSTM) neural network. For example, in the above described exemplary implementation, the plurality of encoded hidden state vectors may be represented as [[0.1323, 0.33234, 0.3765, 0.8739]]. Further, the decoding unit may generate the plurality of current hidden state vectors based on word embedding associated with each word in the plurality of sentences at a time stamp ‘t’. For example, in the above described exemplary implementation, the plurality of current hidden state vectors may be represented as [0.12, 0.324, 0.765, 0.879].

Further, the attention unit may determine the importance of each word i.e. attention distribution in the input text based on the plurality of encoded hidden state vectors and plurality of current hidden state vectors. For example, in the above described exemplary implementation, the word “BORN” may have an attention distribution of 0.23, the word “BORN” may have an attention distribution of 0.23, the word “IN” may have an attention distribution of 0.004, the word “HAWAII” may have an attention distribution of 0.22, the non-textual character “,” may have an attention distribution of 0.001, the word “OBAMA” may have an attention distribution of 0.20, the word “IS” may have an attention distribution of 0.002, the word “A” may have an attention distribution of 0.0034, the word “US” may have an attention distribution of 0.20, and the word “CITIZEN” may have an attention distribution of 0.13.

Further, the context unit may compute the context vector of the plurality of sentences based on the attention distribution of each word in the plurality of sentences and the plurality of encoded hidden state vectors. For example, in the above described exemplary implementation, the context vector may be represented as [0.36, 0.14, 0.765, 0.0879]. Further, the probabilities distribution unit may compute the probability distribution of each of the plurality of words in the plurality of sentences based on the plurality of encoded hidden state vectors, the plurality of current hidden state vectors, and the vocabulary distribution to generate the plurality of relations. For example, in the above described exemplary implementation, the below mentioned 3 relations will be extracted.
Relation 1: The relation of “CITIZENSHIP” between “OBAMA” and “US”
Relation 2: The relation of “PLACE OF BIRTH” between “OBAMA” and “HAWAII”
Relation 3: The relation of “STATE” between “HAWAII” and “US”

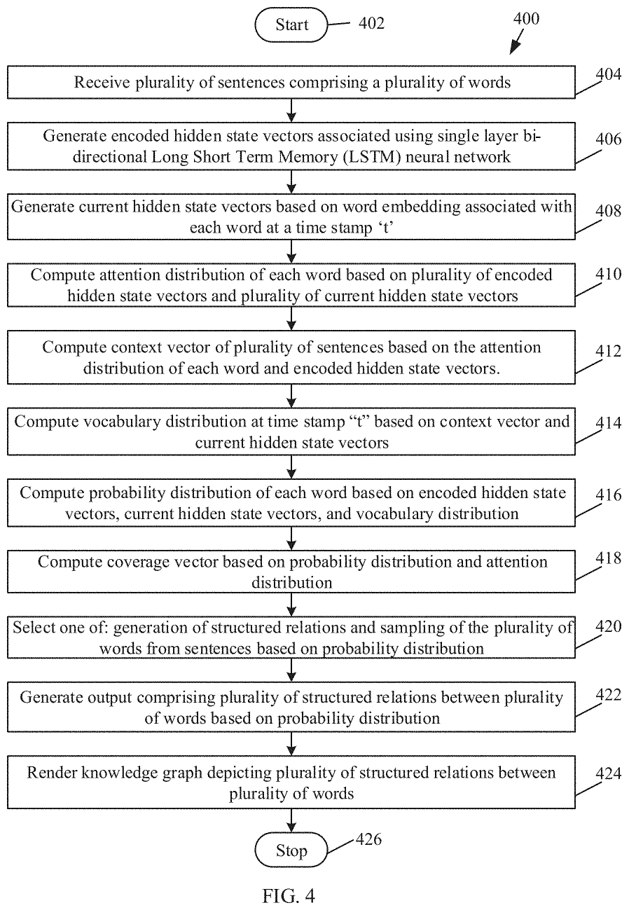

FIG. 4 is a flowchart illustrating a method 400 for generating a plurality of structured relations between a plurality of words in a plurality of sentences, in accordance with some embodiments of the present disclosure. The method starts at step 402 and proceeds to step 404.

At step 404, the application server 104 may be configured to receive a plurality of sentences comprising a plurality of words. In an embodiment, the plurality of sentences comprises numerical data and textual data. At step 406, the application server 104 may be configured to generate a plurality of encoded hidden state vectors associated with the plurality of sentences using a single layer bi-directional Long Short Term Memory (LSTM) neural network. At step 408, the application server 104 may be configured to generate a plurality of current hidden state vectors based on word embedding associated with each word in the plurality of sentences at a time stamp ‘t’. At step 410, the application server 104 may be configured to compute an attention distribution of each word in the plurality of sentences based on the plurality of encoded hidden state vectors and plurality of current hidden state vectors. In an embodiment, the attention distribution is indicative of importance of each word in the plurality of sentences.

At step 412, the application server 104 may be configured to compute a context vector of the plurality of sentences based on the attention distribution of each word in the plurality of sentences and the plurality of encoded hidden state vectors. At step 414, the application server 104 may be configured to compute a vocabulary distribution at the time stamp “t” based on the context vector and the plurality of current hidden state vectors. At step 416, the application server 104 may be configured to compute a probability distribution of each of the plurality of words in the plurality of sentences based on the plurality of encoded hidden state vectors, the plurality of current hidden state vectors, and the vocabulary distribution. At step 418, the application server 104 may be configured to compute a coverage vector based on the probability distribution and the attention distribution. In an embodiment, the coverage vector avoids duplicate generation of relations within the generated plurality of structured relations.

At step 420, the application server 104 may be configured to select one of: generation of structured relations or sampling of the plurality of words from the plurality of sentences based on the probability distribution. At step 422, the application server 104 may be configured to generate an output comprising a plurality of structured relations between the plurality of words based on the probability distribution. At step 424, the application server 104 may be configured to render a knowledge graph depicting the plurality of structured relations between the plurality of words. Control passes to end step 426.

### Computer System

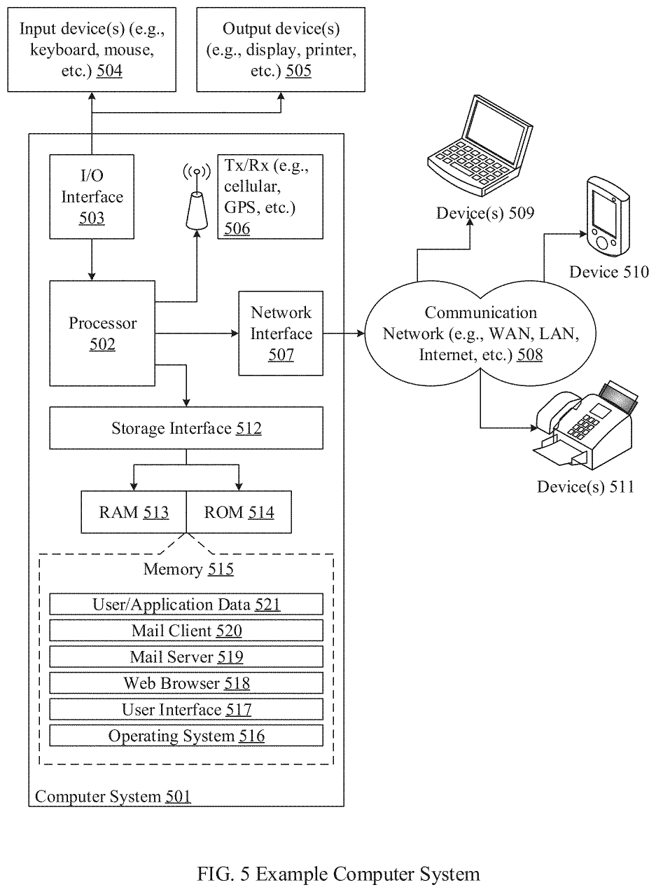

FIG. 5 illustrates a block diagram of an exemplary computer system for implementing embodiments consistent with the present disclosure. Variations of computer system 501 may be used for generating a plurality of structured relations between a plurality of words. The computer system 501 may comprise a central processing unit (“CPU” or “processor”) 502. Processor 502 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD ATHLON, DURON OR OPTERON, ARM′S application, embedded or secure processors, IBM POWERPC, INTEL'S CORE, ITANIUM, XEON, CELERON or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WIMAX, or the like), etc.

Using the I/O interface 503, the computer system 401 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., TEXAS INSTRUMENTS WILINK WL1283, BROADCOM BCM4750IUB8, INFINEON TECHNOLOGIES X-GOLD 618-PMB9800, or the like), providing IEEE 802.11a/b/g/n, BLUETOOTH, FM, GLOBAL POSITIONING SYSTEM (GPS), 2G/3G HSDPA/HSUPA COMMUNICATIONS, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices may include, without limitation, personal computer(s), server(s), fax machines, printers, scanners, various mobile devices such as cellular telephones, smartphones (e.g., APPLE IPHONE, BLACKBERRY, ANDROID-based phones, etc.), tablet computers, eBook readers (AMAZON KINDLE, NOOK, etc.), laptop computers, notebooks, gaming consoles (MICROSOFT)(BOX, NINTENDO DS, SONY PLAYSTATION, etc.), or the like. In some embodiments, the computer system 501 may itself embody one or more of these devices.

In some embodiments, the processor 502 may be disposed in communication with one or more memory devices 515 (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, APPLE MACINTOSH OS X, UNIX, UNIX-like system distributions (e.g., Berkeley Software Distribution (BSD), FreeBSD, NetBSD, OpenBSD, etc.), Linux distributions (e.g., RED HAT, UBUNTU, KUBUNTU, etc.), IBM OS/2, MICROSOFT WINDOWS (XP, VISTA/7/8, ETC.), APPLE IOS, GOOGLE ANDROID, BLACKBERRY OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems’ AQUA, IBM OS/2, MICROSOFT WINDOWS (e.g., Aero, Metro, etc.), UNIX X-WINDOWS, web interface libraries (e.g., ACTIVEX, JAVA, JAVASCRIPT, AJAX, HTML, ADOBE FLASH, etc.), or the like.

In some embodiments, the computer system 501 may implement a web browser 518 stored program component. The web browser 518 may be a hypertext viewing application, such as MICROSOFT INTERNET EXPLORER, GOOGLE CHROME, MOZILLA FIREFOX, APPLE SAFARI, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE FLASH, JAVASCRIPT, JAVA, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ACTIVEX, ANSI C++/C#, MICROSOFT .NET, CGI SCRIPTS, JAVA, JAVASCRIPT, PERL, PHP, PYTHON, WEBOBJECTS, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as APPLE MAIL, MICROSOFT ENTOURAGE, MICROSOFT OUTLOOK, MOZILLA THUNDERBIRD, etc.

In some embodiments, computer system 501 may store user/application data 521, such as the data, variables, records, etc. as described in this disclosure. Such databases may be implemented as fault-tolerant, relational, scalable, secure databases such as ORACLE OR SYBASE. Alternatively, such databases may be implemented using standardized data structures, such as an array, hash, linked list, struct, structured text file (e.g., XML), table, or as object-oriented databases (e.g., using OBJECTSTORE, POET, ZOPE, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

The advantages of the disclosed method and system include generating a plurality of structured relations between a plurality of words. Conventional techniques merely generate a single relationship between a pair of entities. Further, the disclosed method and system do not consider different entities in a same way and are not only based on the sentence semantics and thus eliminate ambiguity during relation extraction. For example: “Ankit is a citizen of India” and “Ankit is a citizen of Bangalore” both will generate same relation using a conventional system. With the help of disclosed method and system, it is possible to differentiate the entities “Bangalore” and “India” for a better decision making.

Further, the disclosed method and system consider the inter connections between the plurality of sentences and generate plurality of relations between the same entities in different sentences. Thus, the relations extracted by the disclosed method and system are much more accurate and the represented structured data either in the form of a knowledge graph or a table may be effectively used for further analysis, processing, better insights and decision making. Further, the output generated by the disclosed method and system is independent of the output length and the sentence length. Further, the disclosed method and system ensure that even if a word has a poor embedding then also such a word will be captured as part of the output. In conventional systems, due to the limited size of the vocabulary, all non-vocabulary words (example: numeric data, special characters) are treated in a same way by an unknown embedding.

Existing state-of-the-art techniques use word embedding for relation extraction. As a result, the numeric input cannot be considered as entities. The disclosed method and system considers numeric values as entities. In addition, the modified pointer neural network helps to remove ambiguity due to out of vocabulary words. In addition, the words, which appear less frequently, will have poor embedding. In conventional systems, such words having poor embedding are clustered together with unrelated words and it makes the network very painful to reproduce such words at the output, leading to loss of information and thus inaccuracy in extracting the relations.

Thus, the disclosed method and system ensure more accurate generation of the plurality of relations without missing out on any of the relations by considering additional inputs/parameters from the probability distribution unit, coverage unit, context unit and the vocabulary distribution unit in copy distribution and then applying softmax on it. However, in the conventional systems, the output is generated by just applying the softmax on copy distribution. This helps distinguishing out of vocabulary words in a more efficient and accurate way. Further, in the disclosed method and system attention distribution and copy distribution is taken into consideration for computing the coverage vector. However, in the conventional systems, the coverage mechanisms only take into consideration of the attention distribution.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for generating a plurality of structured relations between a plurality of words in a plurality of sentences, the method comprising:
receiving, by a processor, a plurality of sentences comprising a plurality of words, wherein the plurality of sentences comprises numerical data and textual data;
generating, by the processor, a plurality of encoded hidden state vectors associated with the plurality of sentences using a single layer bi-directional Long Short Term Memory (LSTM) neural network;
generating, by the processor, a plurality of current hidden state vectors based on word embedding associated with each word in the plurality of sentences at a time stamp ‘t’;
computing, by the processor, an attention distribution of each word in the plurality of sentences based on the plurality of encoded hidden state vectors and plurality of current hidden state vectors, wherein the attention distribution is indicative of importance of each word in the plurality of sentences;
computing, by the processor, a context vector of the plurality of sentences based on the attention distribution of each word in the plurality of sentences and the plurality of encoded hidden state vectors;
computing, by the processor, a vocabulary distribution at the time stamp “t” based on the context vector and the plurality of current hidden state vectors;
computing, by the processor, a probability distribution of each of the plurality of words in the plurality of sentences based on the plurality of encoded hidden state vectors, the plurality of current hidden state vectors, and the vocabulary distribution;
generating, by the processor, an output comprising a plurality of structured relations between the plurality of words based on the probability distribution; and
rendering, by the processor, a knowledge graph depicting the plurality of structured relations between the plurality of words.

2. The method of claim 1, further comprising computing a coverage vector based on the probability distribution and the attention distribution, wherein the coverage vector avoids duplicate generation of relations within the generated plurality of structured relations.

3. The method of claim 1, further comprising selecting one of: generation of structured relations or sampling of the plurality of words from the plurality of sentences based on the probability distribution.

4. The method of claim 1, wherein the probability distribution includes a pointer mechanism to control when to generate a new relation or to copy the received words to the output, wherein the probability distribution is further indicative of a location of a word in the plurality of sentences, and wherein based on the pointer mechanism words in the plurality of sentences are directly copied from the received plurality of sentences to the output, and wherein the output is independent of an output length.

5. The method of claim 1, wherein the plurality of current hidden state vectors is used to generate a plurality of output words that is indicative of mapping of the plurality of words in the plurality of sentence.

6. The method of claim 1, wherein the context vector is a weighted sum between the attention distribution and the plurality of encoded hidden state vectors.

7. The method of claim 1, wherein the context vector is further concatenated with the plurality of current hidden state vectors at the time stamp “t”.

8. The method of claim 1, wherein the plurality of words in the plurality of sentences correspond to plurality of annotated entities.

9. An application server to generate a plurality of structured relations between a plurality of words in a plurality of sentences, the application server comprising:
a processor; and
a memory communicatively coupled to the processor, wherein the memory stores processor instructions, which, on execution, causes the processor to:
receive a plurality of sentences comprising a plurality of words, wherein the plurality of sentences comprises numerical data and textual data;
generate a plurality of encoded hidden state vectors associated with the plurality of sentences using a single layer bi-directional Long Short Term Memory (LSTM) neural network;
generate a plurality of current hidden state vectors based on word embedding associated with each word in the plurality of sentences at a time stamp ‘t’;
compute an attention distribution of each word in the plurality of sentences based on the plurality of encoded hidden state vectors and plurality of current hidden state vectors, wherein the attention distribution is indicative of importance of each word in the plurality of sentences;
compute a context vector of the plurality of sentences based on the attention distribution of each word in the plurality of sentences and the plurality of encoded hidden state vectors;
compute a vocabulary distribution at the time stamp “t” based on the context vector and the plurality of current hidden state vectors;
compute a probability distribution of each of the plurality of words in the plurality of sentences based on the plurality of encoded hidden state vectors, the plurality of current hidden state vectors, and the vocabulary distribution;
generate an output comprising a plurality of structured relations between the plurality of words based on the probability distribution; and
render a knowledge graph depicting the plurality of structured relations between the plurality of words.

10. The application server of claim 9, wherein the processor is further configured to compute a coverage vector based on the probability distribution and the attention distribution, wherein the coverage vector avoids duplicate generation of relations within the generated plurality of structured relations.

11. The application server of claim 9, wherein the processor is further configured to select one of: generation of structured relations or sampling of the plurality of words from the plurality of sentences based on the probability distribution.

12. The application server of claim 9, wherein the probability distribution includes a pointer mechanism to control when to generate a new relation or to copy the received words to the output, wherein the probability distribution is further indicative of a location of a word in the plurality of sentences, and wherein based on the pointer mechanism words in the plurality of sentences are directly copied from the received plurality of sentences to the output, and wherein the output is independent of an output length.

13. The application server of claim 9, wherein the plurality of current hidden state vectors is used to generate a plurality of output words that is indicative of mapping of the plurality of words in the plurality of sentence.

14. The application server of claim 9, wherein the context vector is a weighted sum between the attention distribution and the plurality of encoded hidden state vectors.

15. The application server of claim 9, wherein the context vector is further concatenated with the plurality of current hidden state vectors at the time stamp “t”.

16. The application server of claim 9, wherein the plurality of words in the plurality of sentences correspond to plurality of annotated entities.

17. A non-transitory computer-readable storage medium having stored thereon, a set of computer-executable instructions for causing a computer comprising one or more processors to perform steps comprising:
receiving a plurality of sentences comprising a plurality of words, wherein the plurality of sentences comprises numerical data and textual data;
generating a plurality of encoded hidden state vectors associated with the plurality of sentences using a single layer bi-directional Long Short Term Memory (LSTM) neural network;
generating a plurality of current hidden state vectors based on word embedding associated with each word in the plurality of sentences at a time stamp ‘t’;
computing an attention distribution of each word in the plurality of sentences based on the plurality of encoded hidden state vectors and plurality of current hidden state vectors, wherein the attention distribution is indicative of importance of each word in the plurality of sentences;
computing a context vector of the plurality of sentences based on the attention distribution of each word in the plurality of sentences and the plurality of encoded hidden state vectors;
computing a vocabulary distribution at the time stamp “t” based on the context vector and the plurality of current hidden state vectors;
computing a probability distribution of each of the plurality of words in the plurality of sentences based on the plurality of encoded hidden state vectors, the plurality of current hidden state vectors, and the vocabulary distribution;
generating an output comprising a plurality of structured relations between the plurality of words based on the probability distribution; and
rendering a knowledge graph depicting the plurality of structured relations between the plurality of words.
